(19) United States
(12) Patent Application Publication
(10) Pub. No.: US 2020/0302118 A1
(43) Pub. Date: Sep. 24, 2020

(54) Korean Named-Entity Recognition Method Based on Maximum Entropy Model and Neural Network Model

(71) Applicant: Glabal Tone Communication Technology Co., Ltd., Beijing (CN)

(72) Inventors: Guogen CHENG, Beijing (CN); Shiqi LI, Beijing (CN)

(73) Assignee: Glabal Tone Communication Technology Co., Ltd., Beijing (CN)

(21) Appl. No.: 16/315,661

(22) PCT Filed: Jan. 5, 2018
(86) PCT No.: PCT/CN2018/071628

§ 371 Date: Jan. 7, 2019

(30) Foreign Application Priority Data
Jul. 18, 2017 (CN) 201710586675.2

(51) Int. Cl. G06F 40/295; G06F 40/263; G06F 40/242; G06N 3/08; G06N 3/04

(52) U.S. Cl. CPC G06F 40/295; G06F 40/263; G06N 3/04; G06N 3/08; G06F 40/242

(57) ABSTRACT

A Korean named entity recognition method based on a maximum entropy model and a neural network model, which includes: building a prefix tree dictionary, wherein when a template for any combined noun or a template of any proper noun is matched with an input sentence, the combined noun or proper noun is recognized as a target word; obtaining the target word from a target word selection module and searching for the target word in an entity dictionary, wherein when only one subcategory is matched, the subcategory is used as a tag for the target word; using the maximum entropy model and multiple kinds of linguistic information; constructing a feed-forward neural network mode; and combining adjacent words into an entity tag according to a template selection rule.

### CROSS REFERENCE TO RELATED APPLICATIONS

This application is the national phase entry of International Application PCT/CN2018/071628, filed on Jan. 5, 2018, which is based upon and claims priority to Chinese Patent Application No. 201710586675.2, filed on Jul. 18, 2017, the entire contents of which are incorporated herein by reference.

### TECHNICAL FIELD

The present invention relates to the technical field of named entity recognition, particularly to a Korean named entity recognition method based on maximum entropy model and neural network model.

### BACKGROUND

Named Entity Recognition (NER) is a basic task in natural language processing. The research subject, i.e. the named entity, generally includes three main categories (i.e. entity, time, and number) and seven subcategories (i.e. person's name, location name, organization name, time, date, currency, and percentage). The entities of time and number can be recognized by a finite state machine, which is relatively simple. However, the entity categories such as person's name, location name, organization name, and the like have uncertain characteristics. New named entities are constantly created, and in many conditions, the meanings of them are ambiguous. In order to accurately tag the types of the named entities, a semantic hierarchy analysis is often involved. In addition, there are no specific features in Korean named entities like the capitalized characteristics of the first letter in English, which makes it even harder to recognize Korean named entities.

At present, two methods are generally used for entity recognitions. According to one method, the named entity recognition is performed based on rules and entity dictionaries. This method requires to create a large number of linguistic rules manually, which is cumbersome, costly and has poor portability. According to another method, the entity recognition is performed based on statistical methods, and a statistical model is trained by manually tagged corpus to tag new named entities. A hidden Markov model is commonly used as the statistical model. However, in practice, the independent constraint among the characteristics of the model is hard to satisfy, and the generalization ability is poor. Conditional random field model is another widely used statistical model which is often used in sequence labeling. In the conditional random field model, the relationship of adjacent words in a sequence is modeled, so the selection of features is flexible enough, and the conditions of the features are not required to be independent from each other. However, this model has difficulty in dealing with the problem of out-of-vocabulary words, and has a poor effect on named entity recognition in open fields. A deep neural network model can use word-level and character-level expressions and use the characteristics of automatic learning to predict the tags through context sliding windows. This method has drawbacks in that a large scale of corpus training is required, the cost for the training is high, and the determination of hyperparameters of the deep neural network lacks relevant theoretical guidance. Moreover, the obtained model is complex, prone to overfitting, and has poor portability and generalization ability.

In a word, the prior art has the following problems. The current named entity recognition has a cumbersome process, is costly, has poor portability, complex calculation processes for the model, poor generalization ability, and is unable to deal with out-of-vocabulary words.

### SUMMARY

In view of the problems of the prior art, the present invention provides a named entity recognition method based on maximum entropy model, neural network model, and template matching.

The present invention is realized by a Korean named entity recognition method based on maximum entropy model and neural network model. The Korean named entity recognition method based on maximum entropy model and neural network model includes:
(1) building a prefix tree dictionary, wherein when a template of any combined noun or a template of any proper noun is matched with an input sentence, the combined noun or proper noun is recognized as a target word;
(2) obtaining the target word from a target word selection module, and searching for the target word in an entity dictionary, wherein when only one subcategory is matched, the subcategory is used as a tag for the target word;
(3) directly performing a role tagging on characters to obtain a role tag sequence with a maximum probability by using a maximum entropy model and multiple kinds of linguistic information, and effectively identifying the named entity by performing a pattern matching according to a tag name;
(4) constructing a feed-forward neural network model, wherein inputs and outputs of multiple neuron nodes are connected to each other to form a network and the network is layered; and
(5) combining adjacent words into an entity tag according to a template selection rule.

Further, the prefix tree dictionary consists of a part-of-speech tag sequence and clue word information.

Further, the entity dictionary includes a general dictionary and a domain dictionary;

the general dictionary is manually constructed and the domain dictionary is automatically learned from a training corpus; the general dictionary includes three categories: person, location, and organization;

a person category includes a full name, a surname, and a given name; the full name is collected from a Seoul Telephone Directory, and the surname and the given name are automatically extracted from the full name; and a location name and an organization name are collected from a website.

Further, in the step of directly performing the role tagging on the characters to obtain the role tag sequence with the maximum probability by using the maximum entropy model and the multiple kinds of linguistic information, and effectively identifying the named entity by performing the pattern matching according to simple tag names, the maximum entropy model realizes a feature selection and a model selection.

Further, a probability model of the maximum entropy is defined in a space of H*T, wherein H represents a feature set of all features in a context. A range of the context of a specific character may be selected to include two previous characters and two next characters. The features include features of a character itself and linguistic feature information. T represents a role tag set of all possible role tags of a character, hᵢ represents a given specific context, and tᵢ represents a specific role tag.

Given the specific context hᵢ, a conditional probability of the specific role tag tᵢ is shown in formula (1) below:

$$p ( {t}_{i} \vert {h}_{i} ) = \frac{p ( {h}_{i} , {t}_{i} )}{{\sum }_{{t}^{′} ∈ T} p ( {h}_{i} , {t}_{i}^{′} )} \qquad ( 1 )$$

Formula (1) represents a percentage of the probability of the specific role tag tᵢ in an overall probability given the specific context hᵢ. The overall probability refers to the sum of the probabilities of various specific role tags tᵢ given the specific context hᵢ:

$$p ( {h}_{i} , {t}_{i} ) = π μ {\sum }_{j = 1}^{n} {α}_{j}^{{f}_{j} ( {h}_{i} , {t}_{i} )} \qquad ( 2 )$$

Formula (2) represents the probability of obtaining the specific role tag tᵢ given the specific context hᵢ, wherein π is a regularization constant, {μ,α₁,α₂, . . . ,αₙ} are model parameters, {ƒ₁, ƒ₂, . . . , ƒₙ} are characteristic functions, and αⱼ represents a weight of the jₜₕ feature, each feature is represented by a characteristic function ƒⱼ, the characteristic function is a two-valued function, and the characteristic function is expressed by the following formula:

$${f}_{j} ( {h}_{i} , {t}_{i} ) = \{ \begin{matrix}1 & if {t}_{i} = 10 and suffix ( {w}_{i} ) = “ suffix of location name ” \\ 0 & else\end{matrix} ;$$

wherein, wᵢ is a to-be-processed character, suffix(wᵢ) is a suffix feature of the to-be-processed character.

For each characteristic function ƒᵢ(hᵢ, tᵢ), the constraints of the model are as follows: an expected value of a probability distribution established by the model should be equal to an expected value of a distribution of a trained sample; parameters {μ, α₁, α₂, . . . , αₙ} aim to select a probability of maximum training data relative to the probability distribution P, and to optimize a maximum entropy of the probability distribution P.

Further, when a result value is greater than a predetermined threshold, the target word gets a tag. When a difference between two current maximum values is less than a predetermined threshold, the target word gets a multi-tag and the threshold is set according to experience.

Further, different characteristic functions are determined according to different requirements:

whether prefix and suffix information of a person's name is contained in a limited context;

whether a suffix of a location name is contained in the limited context and a length of the suffix;

whether a suffix of an organization name is contained in the limited context and a length of the suffix;

whether information of a surname and the like is contained in the limited context; whether there are a person's name string and a character of “ [symbol] <and>” before a current character;

whether there are a location name string and the character of “ [symbol] <and>” before the current character;

whether there are an organization name string and the character of “ [symbol] <and>” before the current character; and
whether there are the character of “ [symbol] <and>” and the person's name string before the current character.

Further, a processing method for multi-tag ambiguity includes:

a complex and nonlinear objective function y=F_{θ}(x), wherein, parameters of the function are estimated through training to make the complex and nonlinear objective function approximately reflect a mapping relationship of any tag pair in a fitted sample set, namely, to make F_{θ}(x) satisfy the following relation:

Xⱼ⁽ⁱ⁾ [symbol] Yⱼ⁽ⁱ⁾(where i=1 . . . n,j=1 . . . lenᵢ)

building the model by using a neural network containing multiple neurons, an input of the neuron consists of three variables (x₁, x₂, x₃) and a bias unit b, each line connected to the input corresponds to a weight value of each input unit, and the input is calculated by function y=h_{W,b}(x), the formula is expressed as below:

H_{W,b}(x)=ƒ(w₁x₁+w₂x₂+w₃x₃+b)=ƒ(Σᵢ₌₁³wᵢxᵢ+b).

An input vector consists of n input neuron nodes is X(x₁, x₂ . . . , xₙ), a vector consists of m output nodes is Y(y₁, y₂, . . . , yₘ), and the number of hidden layer node is one. Correspondingly, the number of lines connected between the input layer and the hidden layer is n×l, and the number of lines connected between the hidden layer and the output layer is l×m. Assuming that parameter matrixes consisted of line weights are W⁽¹⁾, W⁽²⁾, respectively, the bias units of the input layer and the hidden layer are b⁽¹⁾,b⁽²⁾, and activation functions of the hidden layer and the output layer are g(x), ƒ(x), respectively, then for each hᵢ, (i=1, 2, . . . , l) of the hidden layer node of the model, the following equation can be obtained:

hᵢ=g(Σ_{j=1→n}Wᵢⱼ⁽¹⁾xⱼ+b⁽¹⁾);

for each output node yᵢ, (i=1, 2, . . . , m), the following equation can be obtained:

yᵢ=ƒ(Σ_{j=1→l}Wᵢⱼ⁽²⁾hⱼ+b⁽²⁾);

and for any input vector X(x₁, x₂, . . . , xₙ), the output vector Y(y₁, y₂ . . . , yₘ) can be calculated by passing forward.

The step of combining the adjacent words into the entity tag according to the template selection rule includes: automatically extracting the template selection rule from the training corpus to combine the adjacent words into the entity tag; wherein the template selection rule is extracted according to entity tag information, vocabulary information, clue word dictionary, and part-of-speech tag information.

Another objective of the present invention is to provide a named entity recognition system based on maximum entropy model, neural network model, and template matching of the named entity recognition method based on maximum entropy model, neural network model, and template matching. The named entity recognition system based on maximum entropy model, neural network model, and template matching includes:

an entity detection module for extracting named entities from a text;

an entity classification module for classifying the named entities as person's name, location name, and organization name.

Further, the entity detection module includes a target-word selecting unit, an entity searching dictionary unit, and an out-of-vocabulary word processing unit; the entity classification module includes a multi-tag entity disambiguation unit and an adjacent word combining unit;

the target-word selecting unit is used to select the target word according to a Korean part-of-speech tag and the clue word dictionary;

the entity-searching dictionary unit is used to search the target word in the entity dictionary;

the out-of-vocabulary word processing unit is used to process out-of-vocabulary words by the maximum entropy model;

the target-word selecting unit and the entity-searching dictionary unit give each target word an entity tag or a temporary multi-tag;

the multi-tag entity disambiguation unit solves an ambiguity problem through the neural network, and the tags used in the neural network are selected from adjacent part-of-speech tags; and

the adjacent word combining unit gives the adjacent words an entity tag according to the template rule.

The advantages and positive effects of the present invention are as follows. The present invention includes the selection of the target words and the search in an entity dictionary. The out-of-vocabulary words are processed by maximum entropy, and then the ambiguity problem is solved by using a neural network. The adjacent words are combined into an entity tag by using a rule template. All data used is extracted from the tagged training corpus and domain-independent entity dictionary, so that the present invention can be easily transferred to other application fields without significantly reducing the performances.

### BRIEF DESCRIPTION OF THE DRAWINGS

FIG. 1 is a flowchart of a Korean named entity recognition method based on a maximum entropy model and a neural network model provided by an embodiment of the present invention.

FIG. 2 is a structural schematic diagram of a Korean named entity recognition system based on the maximum entropy model and the neural network model according to an embodiment of the present invention.

In the figure, 1 refers to an entity detection module, 2 refers to an entity classification module.

FIG. 3 is a schematic diagram of neurons according to an embodiment of the present invention.

### DETAILED DESCRIPTION OF THE EMBODIMENTS

In order to clarify the objectives, technical solutions, and advantages of the present invention, the present invention is further described in detail in combination of the embodiments hereinafter. It should be understood that the specific embodiments described herein are merely used to illustrate the present invention rather than limit the present invention.

The principles for applying the present invention are described in detail with reference to the drawings hereinafter.

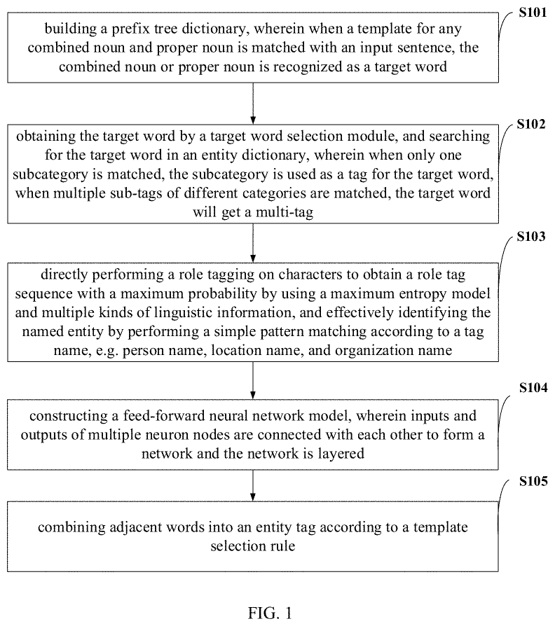

As shown in FIG. 1, the Korean named entity recognition method based on a maximum entropy model and a neural network model according to an embodiment of the present invention includes the following steps:

S101: a prefix tree dictionary is built, and when a template of any combined noun or a template of any proper noun is matched with an input sentence, the combined noun or proper noun is recognized as a target word.

S102: the target word is obtained from a target word selection module, and the target word is searched in an entity dictionary. When only one subcategory is matched, the subcategory is used as a tag for the target word. When multiple sub-tags pertaining to different categories are matched, the target word will get a multi-tag.

S103: a role tagging is directly performed on characters to obtain a role tag sequence with a maximum probability by using a maximum entropy model and multiple kinds of linguistic information, and the named entity (e.g. person's name, location name, and organization name) is effectively identified by performing a simple pattern matching according to tag names.

S104: a feed-forward neural network model is constructed. The inputs and outputs of multiple neuron nodes are connected to each other to form a network and the network is layered.

S105: the adjacent words are combined into an entity tag according to a template selection rule.

The principle for applying the present invention is further described with reference to the drawings, hereinafter.

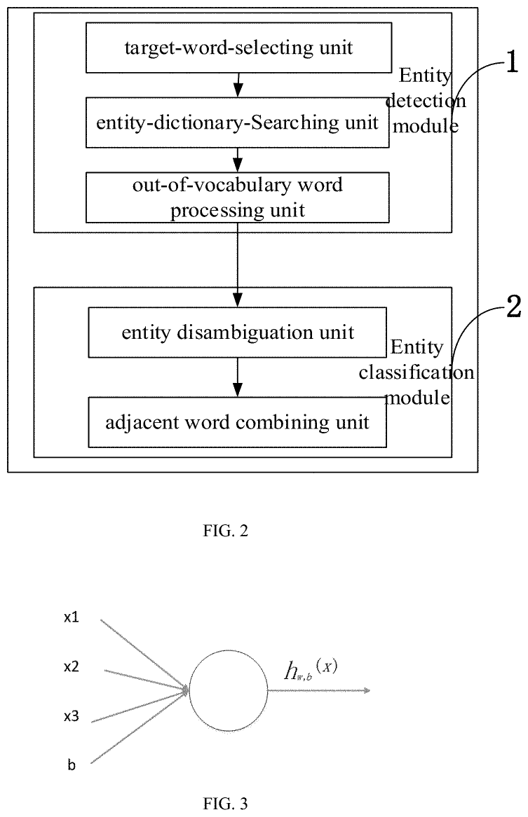

As shown in FIG. 2, a hybrid method based on a maximum entropy model, a neural network model, and a template matching for recognizing Korean named entities of the present invention includes two parts, i.e. an entity detection module 1 and an entity classification module 2.

The entity detection module 1 is configured to extract named entities from a text.

The entity classification module 2 is configured to classify the entities as person's name, location name, and organization name;

the entity detection module 1 includes a target-word selecting unit, an entity searching dictionary unit, and an out-of-vocabulary word processing unit; the entity classification module 2 includes a multi-tag entity disambiguation unit and an adjacent-word combing unit.

the target-word selecting unit is used to select the target word according to a Korean part-of-speech tag and the clue word dictionary;

the entity-searching dictionary unit is used to search the target word in the entity dictionary;

the out-of-vocabulary word processing unit is used to process out-of-vocabulary words by the maximum entropy model;

the target-word selecting unit and the entity-searching dictionary unit give each target word an entity tag or a temporary multi-tag (there are four tag types including person's name/location name tag, location name/organization name tag, person's name/organization name tag, and person's name/location name/organization name tag);

the multi-tag entity disambiguation unit solves an ambiguity problem through the neural network, and the tags used in the neural network are selected from adjacent part-of-speech tags; and

the adjacent word combining unit gives the adjacent words an entity tag according to the template rule.

The present invention aims at recognizing entity tags such as person's name, location name, organization name, etc., and predefining subcategories of person's name, location name, and organization name, as shown in Table 1 below:

TABLE 1
Predefined Subcategories

| Category | Subcategory |
|---|---|
| Person's Name | Politician, Scholar, Economic Figure, Cultural |
| | Figure, Entertainer, Sports Figure, Scientist, |
| | Religious Figure, Relative, and others. |
| Location Name | Country, State, Province, City, Mainland, |
| | Mountain, River, Lake, Sea, Geographical |
| | Location, Scenic Spot, Building, and others. |
| Organization Name | Country, State, City, Company, Political |
| | Organization, School, Laboratory, Association, |
| | Department, Public media, and others. |

The method for named entity recognition based on maximum entropy model, neural network model, and template matching according to the embodiment of the present invention includes the following steps.

Step 1: The target word of the entity is selected.

In Korean, a candidate target word may be a proper noun or a combined noun. The combined noun containing the proper noun can be excluded from the candidate target words.

In order to find the target word, a prefix tree dictionary needs to be constructed in the present invention. The prefix tree dictionary consists of a part-of-speech tag sequence and clue word information. Assuming that the combined noun regarding as the target word will certainly include a clue word after the last common noun, when a template of any combined noun or a template of any proper noun matches with the input sentence, the combined noun or proper noun can be recognized as the target word in the present invention. For example, Seoul (common noun) women's (common noun) university (common noun-organization clue word), an item can be formed in the prefix tree dictionary “common noun: common noun: common noun-organization”.

Step 2: The target word is searched in the entity dictionary.

The entity dictionary includes a general dictionary and a domain dictionary, the general dictionary needs to be constructed manually, and the domain dictionary can be automatically learned from the training corpus. The general dictionary consists of three categories: person, location, and organization. In these three categories, location and organization share some of the same subcategories as shown in Table 1. A person category includes a full name, a surname, and a given name. The full name is collected from a Seoul Telephone Directory, the surname and the given name are automatically extracted from the full name, and a location name and an organization name are collected from a website.

The target word is obtained by the target word selection module and searched from the entity dictionary. When only one subcategory is matched with the target word, the subcategory serves as the tag of the target word. When multiple sub-tags pertaining to different categories are matched with the target word, the target word will get a multi-tag. According to the present invention, assuming that there is no ambiguity among subcategories under a main category. The ambiguity of the target word will be solved by neural network disambiguation module.

Step 3: The out-of-vocabulary words are processed.

Due to the constant creation of person's name, location name and organization, an open set is formed. As a result, the problem of out-of-vocabulary words will be caused.

A role tagging is directly performed on the characters to obtain a role tag sequence with a maximum probability by using a maximum entropy model and multiple kinds of linguistic information, and the named entity (e.g. person's name, location name, organization name) is effectively identified by performing a simple pattern matching according to tag names. The intention of the maximum entropy model is to build a model for all known factors and exclude all unknown factors. A probability distribution that satisfies all known facts and is not affected by any unknown factors should be found. The advantage of the maximum entropy is that it does not require conditional independent features, so features that are useful to the final classifier can be added relatively arbitrarily regardless of the interaction thereamong. The principle of the maximum entropy is that the known things are constraints, and the unknown conditions are uniformly distributed and unbiased. The maximum entropy has two basic tasks, i.e. feature selection and model selection. The feature selection is to select a feature set that can express the statistical features of a random process. The model selection is a model estimation or a parameter estimation, which estimates the weight for each selected feature.

Under the architecture of the maximum entropy model, the maximum entropy model based on the context and role tag information is built by using multiple kinds of effective linguistic feature information The linguistic feature information refers to the character attributes that affect the context. For example, the phrase of “ [symbol] <university>” in the phrase of [symbol] <Korea university> is often used as a suffix of an organization name, so the linguistic feature information of the phrase of “ [symbol] <university>” is the suffix of an organization name. The phrase of “ [symbol] <special city>” in the phrase of [symbol] <Seoul special city> is often used as a suffix of a location name, so the linguistic feature information of the phrase of “ [symbol] <special city>” is the suffix of a location name. The context refers to the attributes of the previous character(s) and the next character(s) of the selected character, such as character role, character type, etc.

According to the present invention, each character in a sentence implicitly carries a piece of role information (the role is an attribute of the character itself), which reflects the role of a single character in a named entity or sentence. The role information defined by the present invention is shown in Table 2:

TABLE 2
Role Information

| Role | Meaning | Example |
|---|---|---|
| 1 | Korean surname | [symbol] (Lee Sun-gyun) |
| 2 | The first character of a | [symbol] (Lee Sun-gyun) |
| | two-word name | |
| 3 | The last character of a | [symbol] (Lee Sun-gyun) |
| | two-word name | |
| 4 | Conjunction | [symbol] (Yoon Eun Hye |
| | | and Lee Sun-gyun) |
| 6 | Head of a location | [symbol] (Chung-cheong bukdo) |
| | name | |
| 7 | Middle of a location | [symbol] (Chung-cheong bukdo) |
| | name | |
| 8 | Tail of a location name | [symbol] (Chung-cheong bukdo) |
| 9 | First character of an | [symbol] (Sookmyung |
| | organization name | Women's University) |
| 10 | Middle character of an | [symbol] (Sookmyung |
| | organization name | Women's University) |
| 11 | Tail character of an | [symbol] (Sookmyung |
| | organization name | Women's University) |
| 12 | First character of a | [symbol] (Saturday) |
| | common noun | |
| 13 | Middle character of a | [symbol] (Saturday) |
| | common noun | |
| 14 | Tail character of a | [symbol] (Saturday) |
| | common noun | |
| 15 | Other entity component | [symbol] (Start) |

A probability model of the maximum entropy is defined in a space of H*T, wherein H represents a feature set of all features in a context. A range of the context of a specific character may be selected to include two previous characters and two next characters. The features include features of a character itself and linguistic feature information. T represents a role tag set of all possible role tags of a character, hᵢ represents a given specific context, and tᵢ represents a specific role tag.

Given the specific context hᵢ, a conditional probability of the specific role tag tᵢ is shown in formula (1) below

$$p ( {t}_{i} \vert {h}_{i} ) = \frac{p ( {h}_{i} , {t}_{i} )}{{\sum }_{{t}^{′} ∈ T} p ( {h}_{i} , {t}_{i}^{′} )} \qquad ( 1 )$$

Formula (1) represents a percentage of the probability of the specific role tag tᵢ in an overall probability given the specific context hᵢ. The overall probability refers to the sum of the probabilities of various specific role tags tᵢ given the specific context

hᵢ:p(hᵢ,tᵢ)=πμΣⱼ₌₁ⁿαⱼ^{ƒ}^{ⱼ}^{(h}^{ᵢ}^{,t}^{ᵢ}⁾ (2)

Formula (2) represents the probability of obtaining the specific role tag tᵢ given the specific context hᵢ, wherein π is a regularization constant, {μ, α₁, α₂, . . . , αₙ} are model parameters, {ƒ₁, ƒ₂ . . . , ƒₙ} are characteristic functions, and αⱼ represents a weight of the jₜₕ feature, each feature is represented by a characteristic function ƒⱼ, the characteristic function is a two-valued function, and the characteristic function is expressed by the following formula:

$${f}_{j} ( {h}_{i} , {t}_{i} ) = \{ \begin{matrix}1 & if {t}_{i} = 10 and suffix ( {w}_{i} ) = “ suffix of place name ” \\ 0 & else\end{matrix} .$$

where wᵢ is a to-be-processed character, suffix(wᵢ) is a suffix feature of the to-be-processed character, and the clue word is shown in the reference Table 2.

For each characteristic function ƒⱼ(hᵢ,tᵢ), the constraints of the model are as follows: an expected value of a probability distribution established by the model should be equal to an expected value of a distribution of a trained sample; parameters {μ, α₁, α₂, . . . , αₙ} aim to select a probability of maximum training data relative to the probability distribution P, and optimize a maximum entropy of the probability distribution P.

When a result value is greater than a predetermined threshold, the target word gets a tag. When a difference between two current maximum values is less than a predetermined threshold, the target word gets a multi-tag and the threshold is set according to experience.

According to the present invention, different characteristic functions are determined according to different requirements:

whether prefix and suffix information of a person's name is contained in a limited context;

whether a suffix of a location name is contained in the limited context and a length of the suffix;

whether a suffix of an organization name is contained in the limited context and a length of the suffix;

whether information of a surname and the like is contained in the limited context;

whether there are a person's name string and a character of “ [symbol] <and>” before a current character;

whether there are a location name string and the character of “ [symbol] <and>” before the current character;

whether there are an organization name string and the character of “ [symbol] <and>” before the current character;

whether there are the character of “ [symbol] <and>” and the person's name string before the current character; and so on.

TABLE 3
Clue Word Dictionary

| No. | Subcategory | Clue word |
|---|---|---|
| 1 | Scholar | [symbol] (Professor), |
| | | [symbol] (Teacher) |
| 2 | Economic | CEO, CTO, |
| | figure | [symbol] (Executive) |
| 3 | Relative | [symbol] (Father) |
| 4 | Politician | [symbol] (President) |
| 5 | Religious figure | [symbol] (Pastor) |
| 6 | Country | [symbol] (Republic) |
| 7 | City | [symbol] (Capital) |
| 8 | State | [symbol] (State) |
| 9 | District | [symbol] (District) |
| 10 | Scenic spot | [symbol] (Park) |
| 11 | Geographical | [symbol] (River), |
| | location | [symbol] (Mountain) |
| 12 | Building | [symbol] (Building) |
| 13 | Association | [symbol] (Club) |
| 14 | Laboratory | [symbol] (Laboratory) |
| 15 | Public media | [symbol] (TV) |
| 16 | School | [symbol] (University) |

Step 4: The ambiguity of multi-tag is addressed.

Some target words are ambiguous because they have a multi-tag which includes person/location tag, location/organization tag, organization/person tag and person/location/organization tag. Therefore, in the present invention, four types of neural networks are learned to address the ambiguity problems of each type.

Given a sufficiently large training corpus T_{Corpus}, there is an arbitrary training sample (X⁽ⁱ⁾, Y⁽ⁱ⁾)∈T_{Corpus}. The corpus contains m samples, and the sequence length of each tag pair (X⁽ⁱ⁾, Y⁽ⁱ⁾) is lenᵢ. The present invention aims to find a complex and nonlinear objective function y=F_{θ}(x), wherein, parameters of the function are estimated through training to make the complex and nonlinear objective function approximately reflect a mapping relationship of any tag pair in a fitted sample set, namely, to make F_{θ}(x) satisfy the following relation:

Xⱼ⁽ⁱ⁾ [symbol] Yⱼ⁽ⁱ⁾ (where i=1 . . . n,j=1 . . . lenᵢ).

A neural network containing multiple “neurons” is used to build the model, in which each “neuron” is a multi-input, single-output arithmetic unit as shown in FIG. 3.

With reference to FIG. 3, the input of the neuron consists of three variables (x₁, x₂, x₃) and a bias unit b, each line connected to the input corresponds to a weight value of each input unit, and the input is calculated by function y=h_{W,b}(x), the formula is expressed as below:

$$\begin{matrix}{H}_{W , p} ( x ) = f ( {w}_{1} {x}_{1} + {w}_{2} {x}_{2} + {w}_{3} {x}_{3} + b ) \\ = f ( {\sum }_{i = 1}^{3} {w}_{i} {x}_{i} + b )\end{matrix}$$

where, the activation function ƒ(z) has multiple choices. Sigmoid function and hyperbolic tangent function are commonly used, and the specific forms thereof are as follows:

$$f ( z ) = sigmoid ( z ) = \frac{1}{1 + {e}^{- z}} ;$$

$$f ( z ) = tanh ( z ) = \frac{{e}^{z} - {e}^{- z}}{{e}^{z} + {e}^{- z}} .$$

In the neural networks, the two functions are used as activation functions, mainly because the derivative values of the functions are easy to be calculated. Meanwhile, by using the sigmoid function, the input value can be compressed and transformed into an output falling within the range of (0,1), which can be treated as the probability value of an activated node in the application. The tanh function can make the output fall within the range of (−1, 1) by nonlinearly scaling, which is widely used in the feature normalization process of the model.

On the basis of neurons, a simple feed-forward neural network model is constructed. The inputs and outputs of multiple “neuron” nodes are connected to each other to form a network, and the network is layered to construct a simple neural network model composed of an input layer, an output layer and a hidden layer.

For the three-layer neural network model, assuming that the input vector consists of n input neuron nodes is X(x₁, x₂, . . . , xₙ), a vector composed of m output nodes is Y(y₁, y₂, . . . , yₘ), and the number of hidden layer node is one. Correspondingly, the number of lines connected between the input layer and the hidden layer is n×l, and the number of lines connected between the hidden layer and the output layer is l×m. Assuming that parameter matrixes consisted of line weights are W⁽¹⁾, W⁽²⁾, respectively, the bias units of the input layer and the hidden layer are b⁽¹⁾, b⁽²⁾, and activation functions of the hidden layer and the output layer are g(x), ƒ(x), respectively, for each hᵢ, (i=1, 2, . . . , l) of the hidden layer node of the model, the following equation can be obtained:

hᵢ=g(Σ_{j=1→n}Wᵢⱼ⁽¹⁾xⱼ+b⁽¹⁾);

for each output node yᵢ, (i=1, 2, . . . , m), the following equation can be obtained:

yᵢ=ƒ(Σ_{j=1→l}Wᵢⱼ⁽²⁾hⱼ+b⁽²⁾);

given a neural network model, for any input vector X(x₁, x₂, . . . , xₙ), the output vector Y(y₁, y₂, . . . , yₘ) can be calculated by passing forward the two formulas above. Such calculation process of solving the output based on the given input is generally called the forward propagation process in the neural network.

According to the present invention, the standard back-propagation algorithm is used as the learning algorithm. The neural network includes an input layer, a hidden layer, and an output layer. The output layer has 2 or 3 nodes (when the multi-tag has three categories, 3 nodes are used).

The input method of each network includes two parts, one part uses the part-of-speech tag information, and the other part uses the vocabulary information.

The part-of-speech tag information adjacent to the target word is regarded as an important feature. After removing the useless part-of-speech tags such as verb tags, according to the present invention, the part-of-speech tag is extracted from two part-of-speech tags at the left side of the target word and two part-of-speech tags at the right side of the target word. Then, according to the present invention, a useful tag set is defined at each location and the useful tag sets are used as input features. There are 55 part-of-speech tags used as the input features in total.

Similarly, in the present invention, the vocabulary information is extracted from the same range without verb vocabulary information. Therefore, a clue word dictionary with five new categories is used in the present invention, which is an extended version of the clue word dictionary shown in Table 3. In the end, there are 26 features used to indicate whether a given word belongs to the clue word dictionary. Table 4 shows the added categories of the new clue word dictionary.

TABLE 4
New Categories Added to the Clue
Word Dictionary

| No. | Subcategory | Prompt word |
|---|---|---|
| 17 | Person's name | [symbol] (Member) |
| 18 | Location name | [symbol] (Village), |
| | | [symbol] (Around) |
| 19 | Organization name | [symbol] (Group) |
| 20 | Verb clue word of | [symbol] (Leave), |
| | location name | [symbol] (Arrive) |
| 21 | Verb clue word of | [symbol] (Declare), |
| | organization name | [symbol] (Have) |

The clue categories of the person, location, and organization in Table 4 do not have any correspondence in Table 2. The location and organization verb categories are mainly used to solve the ambiguity among the location names and organization names. All the features in the neural network are represented in binary.

Step 5: The adjacent words are combined as an entity tag according to the template selection rules.

By disambiguation, a word is given with an entity tag. But in some cases, such as the phrase of “President Kim day-cwung”, it would be clearer when the phrase “Kim day-cwung” is followed by the adjacent clue word “President”. A detailed entity subcategory will be obtained through the model in this example.

According to the present invention, the template selection rules are automatically extracted from the training corpus in order to combine the adjacent words into an entity tag. The template selection rules are extracted according to the entity tag information, vocabulary information, clue word dictionary in Table 3, and part-of-speech tag information. In the end, 191 template selection rules are obtained.

An example of the template selection rules is as follows:

[Political person]=[Person]+{political CLUE}

Example: <kim-day-cwung (kim-day-cwung) [Person] tay-thong-lyeng (President) [CLUE:Political person]>[Political person]

The principle for applying the present invention is further described in combination of the specific embodiment below.

For example, President Kim day-cwung began his first job in the Blue House with Lee je-ho.

TABLE 5

| | | | | | | | | | | |
|---|---|---|---|---|---|---|---|---|---|---|
| Korean: | [symbol] | [symbol] | [symbol] | [symbol] | [symbol] | [symbol] | [symbol] | [symbol] | [symbol] | [symbol] |
| Englis: | (Kim day-cwung ) | (President) | (and) | (Lee je-ho) | | (blue house) | (from) | (first) | (job) | (began) |
| Part of speech: | NNC | NNC-PSN | PCJ | NNC | PP | NNC | PP | NNU | NNC | VV |

in the sentence,

NNC represents normal nouns;

NNC-PSN represents normal nouns with clue information;

PCJ represents conjunctions;

PP represents auxiliary words ( [symbol] is subject auxiliary word, [symbol] is location auxiliary word);

NNU represents normal numbers;

VV represents verbs.

Step 1: Look up the prefix tree dictionary, which is constructed by the part-of-speech tags and clue word information sequences. The present invention assumes that the last common noun of the combined word which is regarded as the target word has a clue word. For example, the above example will find a record: “common noun: common noun—person” in the prefix tree dictionary, so as to get the target word “ [symbol] [symbol] (President Kim day-cwung)”.

Step 2: Look up the target word in the entity dictionary. The general entity dictionary includes three categories, i.e. person, location, and organization, and the categories of location and organization share some subcategories, as shown in Table 1. When the target word is found in only one entity dictionary, the target word has a subcategory, and when the target word is found in multiple subcategories belonging to different categories, the target word will have a multi-tag. For example, “ [symbol] ” (The Blue House) not only belongs to the architectural subcategory under the location category, but also belongs to government organization subcategory under the organization category, so “ [symbol] (The Blue House)” has a multi-tag “location/organization” tag.

Step 3, Use maximum entropy to deal with the problem of out-of-vocabulary words. Specifically, a to-be-recognized text is input, then for each character in the out-of-vocabulary words, a feature item of the respective character is established according to the context of the character. For example, in the to-be-recognized text “ [symbol] [symbol] [symbol] <President Kim day-cwung and Lee je-ho were in the blue house>”, the phrase “ [symbol] ” is an out-of-vocabulary word, then a feature item of the character “O|” is established, which includes the following contents: the character is “ [symbol] ” whose type is normal, the first previous word is “ [symbol] ” whose type is conjection, the second previous word is “ [symbol] ” whose type is person's name entity, the first next word is “ [symbol] ” whose type is subject auxiliary word, and the second next word is “ [symbol] ” whose type is location/organization name entity, and the role is to be determined. Also, the feature items of the to-be-recognized text are combined as a sequence to input into the maximum entropy model to obtain the character role tag sequence with a maximum probability of happening of the to-be-recognized text. Ultimately, the phrase of “ [symbol] ” is recognized as a person's name entity by pattern matching.

Step 4: Disambiguate the multiple entity tag through the neural network. The input includes two parts, one part uses the part-of-speech tag information, and the other part uses the vocabulary information. For the to-be-recognized text tagged according to the part of speech, the useless part-of-speech tags such as verb tag are removed, then two part-of-speech tags left to the target word and two part-of-speech tags right to the target word are extracted, respectively. The useful tag set at each location is defined and used as the input features. For example, the target word “ [symbol] ” has the tag of location name/organization name. The part of speech of the first word left to the target word is PP, the second word left to the target word is NNC, the first word right to the target word is PP, and the second word right to the target word is NNU. These features as used as the input features. Similarly, according to the present invention, after removing the verbs in the to-be-recognized text, two words on the left and two words on the right of the target word are extracted to be used as another input feature of the target word. All the eigenvalues in the neural network are expressed in binary. In the end, the recognition result of the target word “ [symbol] ” is the location name entity.

Step 5: Combine the ad tA rds into an entity tag through a template. The phrase “ [symbol] ” in the to-be-recognized sentence is combined into an entity “political figure”.

The recognition result is shown in Table 6.

TABLE 6

| | | | | | | | | | | |
|---|---|---|---|---|---|---|---|---|---|---|
| Korean: | [symbol] | [symbol] | [symbol] | [symbol] | [symbol] | [symbol] | [symbol] | [symbol] | [symbol] | [symbol] |
| English: | (Kim day-cwung) | (President) | (and) | (Lee je-ho) | | (blue house) | (from) | (first) | (job) | (began) |
| Part of speech: | NNC | NNC-PSN | PCJ | NNC | PP | NNC | PP | NNU | NNC | VV |

| | | | |
|---|---|---|---|
| Entity tag: | [Political person] | [person] | [location] |

The foregoing is only a preferred embodiment of the present invention which is not intended to limit the present invention. Any modification, equivalent substitution, and improvement derived within the spirit and principles of the present invention shall be considered as falling within the scope of the present invention.

What is claimed is:

1. A Korean named entity recognition method based on a maximum entropy model and a neural network model, comprising:
building a prefix tree dictionary, wherein when a template of any combined noun or a template of any proper noun is matched with an input sentence, the combined noun or proper noun is recognized as a target word;
obtaining the target word from a target word selection module, and searching for the target word in an entity dictionary, wherein when only one subcategory is matched, the subcategory is used as a tag for the target word;
directly performing a role tagging on characters to obtain a role tag sequence with a maximum probability by using the maximum entropy model and multiple kinds of linguistic information, and identifying the Korean named entity by performing a pattern matching according to a tag name;
constructing a feed-forward neural network model, wherein inputs and outputs of multiple neuron nodes are connected to each other to form a network and the network is layered; and
combining adjacent target words into an entity tag according to a template selection rule.

2. The Korean named entity recognition method based on the maximum entropy model and the neural network model of claim 1, wherein,
the prefix tree dictionary comprises a part-of-speech tag sequence and clue word information.

3. The Korean named entity recognition method based on the maximum entropy model and the neural network model of claim 1, wherein,
the entity dictionary comprises a general dictionary and a domain dictionary;
the general dictionary is manually constructed and the domain dictionary is automatically learned from a training corpus;
the general dictionary comprises three categories: person, location, and organization;
a person category comprises a full name, a surname, and a given name; wherein the full name is collected from a Seoul Telephone Directory, and the surname and the given name are automatically extracted from the full name; and
a location name and an organization name are collected from a website.

4. The Korean named entity recognition method based on the maximum entropy model and the neural network mode of claim 1, wherein,
in the step of directly performing the role tagging on the characters to obtain the role tag sequence with the maximum probability by using the maximum entropy model and the multiple kinds of linguistic information, and identifying the named entity by performing the pattern matching according to tag names, the maximum entropy model realizes a feature selection and a model selection.

5. The Korean named entity recognition method based on the maximum entropy model and the neural network model of claim 4, wherein,
a probability model of the maximum entropy is defined in a space of H*T, wherein H represents a feature set of all features in a context;
a range of the context of a specific character is selected to include two previous characters and two next characters;
the features comprise features of a character itself and linguistic feature information; and
T represents a role tag set of all possible role tags of a character.

6. The Korean named entity recognition method based on the maximum entropy model and the neural network model of claim 5, wherein
when a result value of the maximum entropy model is greater than a first predetermined threshold, the target word gets the tag; and
when a difference between two current maximum result values of the maximum entropy model is less than a second predetermined threshold, the target word gets a multi-tag and the predetermined threshold is set according to experience.

7. The Korean named entity recognition method based on the maximum entropy model and the neural network model of claim 5, wherein, each characteristic function is determined according to at least one of the following conditions:
1) whether prefix and suffix information of a person's name is contained in a limited context;
2) whether a suffix of a location name is contained in the limited context and a length of the suffix;
3) whether a suffix of an organization name is contained in the limited context and a length of the suffix;
4) whether information of a surname and is contained in the limited context;
5) whether there are a person's name string and a character of “ [symbol] <and>” before a current character;
6) whether there are a location name string and the character of “ [symbol] <and>” before the current character;
7) whether there are an organization name string and the character of “ [symbol] <and>” before the current character; and
8) whether there are the character of “ [symbol] <and>” and the person's name string before the current character.

8. A Korean named entity recognition system based on a maximum entropy model, a neural network model, and a template matching according to the Korean named entity recognition method based on the maximum entropy model and the neural network model of claim 1, comprising:
an entity detection module for extracting named entities from a text; and
an entity classification module for classifying the named entities as person's name, location name, and organization name.

9. The Korean named entity recognition system based on the maximum entropy model, the neural network model, and the template matching of claim 8, wherein
the entity detection module comprises a target-word selecting unit, an entity searching dictionary unit, and an out-of-vocabulary word processing unit;
the entity classification module comprises a multi-tag entity disambiguation unit and an adjacent word combining unit;
the target-word selecting unit is used to select the target word according to a Korean part-of-speech tag and the clue word dictionary;
the entity-searching dictionary unit is used to search the target word in the entity dictionary;
the out-of-vocabulary word processing unit is used to process out-of-vocabulary words by the maximum entropy model;
the target-word selecting unit and the entity-searching dictionary unit give each target word an entity tag or a temporary multi-tag;
the multi-tag entity disambiguation unit solves an ambiguity problem through the neural network, and tags used in the neural network are selected from adjacent part-of-speech tags; and
the adjacent word combining unit gives the adjacent words an entity tag according to a template selection rule.
